(19) United States
(12) Patent Application Publication
(10) Pub. No.: US 2023/0237541 A1
(43) Pub. Date: Jul. 27, 2023

(54) KEYSTONE ACTIVITY SUGGESTIONS

(71) Applicant: Capital One Services, LLC, McLean, VA (US)

(72) Inventors: Kathryn Tikoian, South Orange, NJ (US); Lukiih Cuan, Washington, DC (US); Julia Burns, Washington, DC (US); Saeed Khawaja, Fairfax, VA (US); Hari Iyer, Ashburn, VA (US)

(21) Appl. No.: 17/584,309

(22) Filed: Jan. 25, 2022

(51) Int. Cl. G06Q 30/02

(52) U.S. Cl. CPC G06Q 30/0282; G06Q 30/0204

(57) ABSTRACT

The innovation disclosed and claimed herein, in one aspect thereof, comprises systems and methods of keystone activity based suggestions. The innovation detects a keystone activity of a user. The keystone activity is a planned event for the user such as recently purchased tickets to a specific show. Customer data of a financial institution is accessed where the customer data includes data of customers of the financial institution. A set of similar customers to the user is determined. Transaction data of the set of similar customers is determined and analyzed for likelihood of the user wanting to attend a secondary activity that is similar the set of similar customers. The secondary activity can be automatically scheduled for the user based on the keystone activity and the transaction data.

### BACKGROUND

Customers usually make advanced plans for certain activities, particularly while traveling. However, while a customer will make plans for certain activities, e.g. a pre-planned event with tickets that are acquired in advance, the customer will often leave further secondary activities until the last minute. The secondary activities, such as transportation, dining, other related activities, and/or the like, are almost as important as the primary activity and can often use more time to research and plan than the primary activity. The planning of the secondary activities can waste valuable customer time. The customers must balance many factors including maximizing the primary activity, balancing relaxation time with other activities, balancing spontaneity with plans, and/or the like. The customer is often overwhelmed attempting to decide what secondary activities to schedule.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of keystone activity based suggestions. The innovation detects a keystone activity of a user. The keystone activity is a planned event for the user such as recently purchased tickets to a specific show. Customer data of a financial institution is accessed where the customer data includes data of customers of the financial institution. A set of similar customers to the user is determined. Transaction data of the set of similar customers is determined and analyzed for likelihood of the user wanting to attend a secondary activity that is similar the set of similar customers. The secondary activity can be automatically scheduled for the user based on the keystone activity and the transaction data.

In aspects, the subject innovation provides substantial benefits in terms of keystone activity suggestions. One advantage resides in time savings in planning secondary activities. Another advantage resides in automatically scheduling secondary activities based on the keystone activity.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates a high level diagram of the subject innovation.

FIG. 2 illustrates an example component diagram of an activity coordinator.

FIG. 3 illustrates an example component diagram of a recommendation component.

FIG. 4 illustrates a method for keystone activity suggestions.

FIG. 5 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

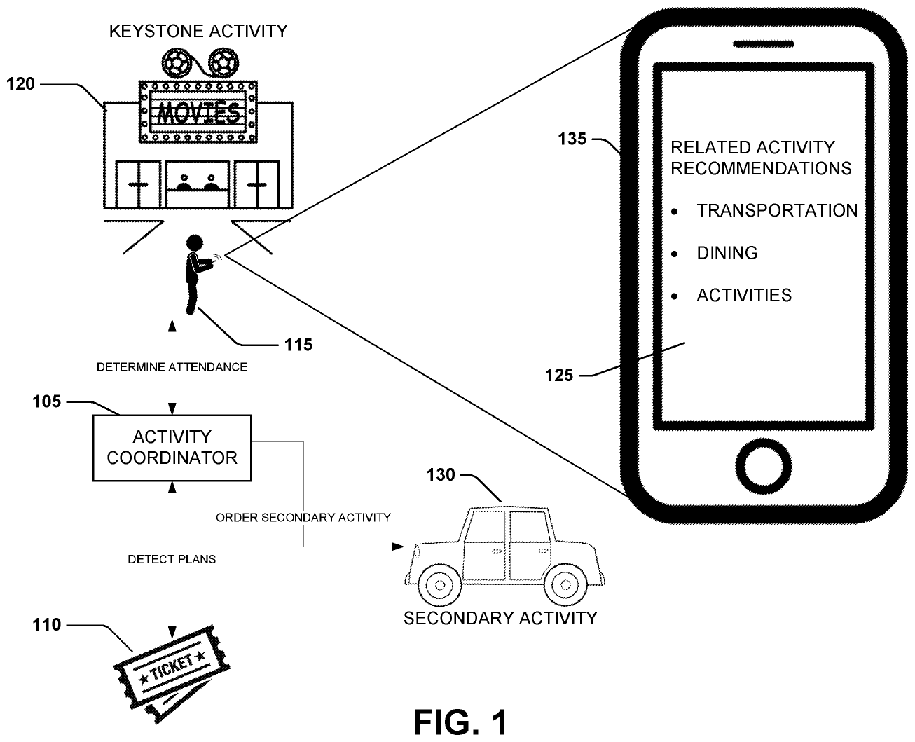

FIG. 1 illustrates a high level view of the subject innovation according to aspects herein. An activity coordinator 105 can detect plans 110 upcoming for a user 115 to attend a keystone activity 120. The activity coordinator 105 can detect plans 110 by monitoring the user 115. The monitoring can include searching the user's 115 transactions, correspondence, and activities to detect plans 110 and/or the keystone activity 120. For example, the activity coordinator 105 can monitor the user's 115 email to search for ticket receipts, reservations, conversations that set up a keystone activity 120, and/or the like. The activity coordinator 105 can utilize optical character recognition OCR, natural language processing NLP, machine learning techniques, computer vision CV, and/or the like to monitor the user 115. For example, the activity coordinator 105 can determine a user transaction that includes a merchant code for a ticketing website. The activity coordinator 105 can access the user's 115 correspondence for a receipt or a conversation with a friend regarding the keystone activity 120. The activity coordinator 105 utilizes natural language processing to read the correspondence to confirm plans 110 for the keystone activity 120.

The activity coordinator 105 can generate activity recommendations 125 based on the keystone activity 120. The activity recommendations 125 can be for secondary activities 130. In some embodiments, the secondary activities 130 succeeds or proceeds the keystone activity 120. The activity recommendations 125 can be presented to the user 115 via a user device 135. Secondary activities can be activities that are related to the keystone activity 120. For example, if the keystone activity 120 is a movie showing at a cinema, a secondary activity 130 can be transportation to and/or from the cinema or a restaurant reservation near the cinema for after the movie showing. The activity coordinator 105 can automatically schedule the transportation or reservation or present the options to the user 115 to confirm the secondary activity 130. In some embodiments, the activity coordinator 105 detects actual attendance of the keystone activity 120 before providing the activity recommendations 125 for after the keystone activity 120. The detection can be performed using location tracking of the user, detecting a scan of tickets, and/or the like. Determining attendance of the user at the keystone activity can be performed via monitoring user transactions, correspondence, or user activities.

The activity coordinator 105 can generate activity recommendations for the user via a variety of techniques. In some embodiments, the activity coordinator 105 can determine other users that are attending the keystone activity 120. The activity coordinator 105 can further determine secondary activities that the other users have planned to base the activity recommendations around.

In other embodiments, the activity coordinator 105 can determine customers that are similar to the user 115. For example, the activity coordinator 105 can access customer information of a plurality of customers associated with a financial institution (e.g. disparate customers). The activity coordinator 105 can determine similar customers to the user 115 that match attributes of the user 115. In some embodiments, the activity coordinator 105 can determine a similarity score between the user 115 and customer data of the financial institution. The activity coordinator 105 determines a set of similar customers to the customer based on the similarity score exceeding a threshold score. The activity coordinator 105 analyzes transaction data of the set of similar customers to determine the activity recommendation. For example, if a majority of the set of similar customers have a transaction for a rideshare transportation to the same area as the keystone activity 120, the activity coordinator 105 recommends that the user 115 use a rideshare transportation instead of driving and parking a personal vehicle.

In some embodiments, the activity coordinator 105 can base the activity recommendations 125 on transaction data of the user 115, past activity data, correspondence data, financial transaction data, and/or other customer data of a financial institution. The activity coordinator 105 can analyze the transaction data according to a recommendation model. The recommendation model can be a model that is trained with the customer data (e.g. training data, a training data set, or input training data) of the financial institution using a machine learning technique to learn trends and/or relationships between data points. The recommendation model can determine a likelihood of a secondary activity 130 being needed or wanted and provide the secondary activities that the user 115 would most likely book.

In some embodiments, the activity coordinator 105 determines whether the user follows or attends an activity recommendation or secondary activity 130. The activity coordinator 105 can update the recommendation model with the attendance to further optimize the recommendation model.

In other embodiments, the activity coordinator 105 can optimize the activity recommendations 125 for further data factors. The data factors can include at least one of distance, demographic, weather, transaction history, social media, wearable device data, augmented reality visualization of the user 115, and/or the like. The data factors can be part of the recommendation model to optimize the activity recommendations. For example, the recommendation model can suggest a rideshare car ride instead of an electric scooter due to inclement weather.

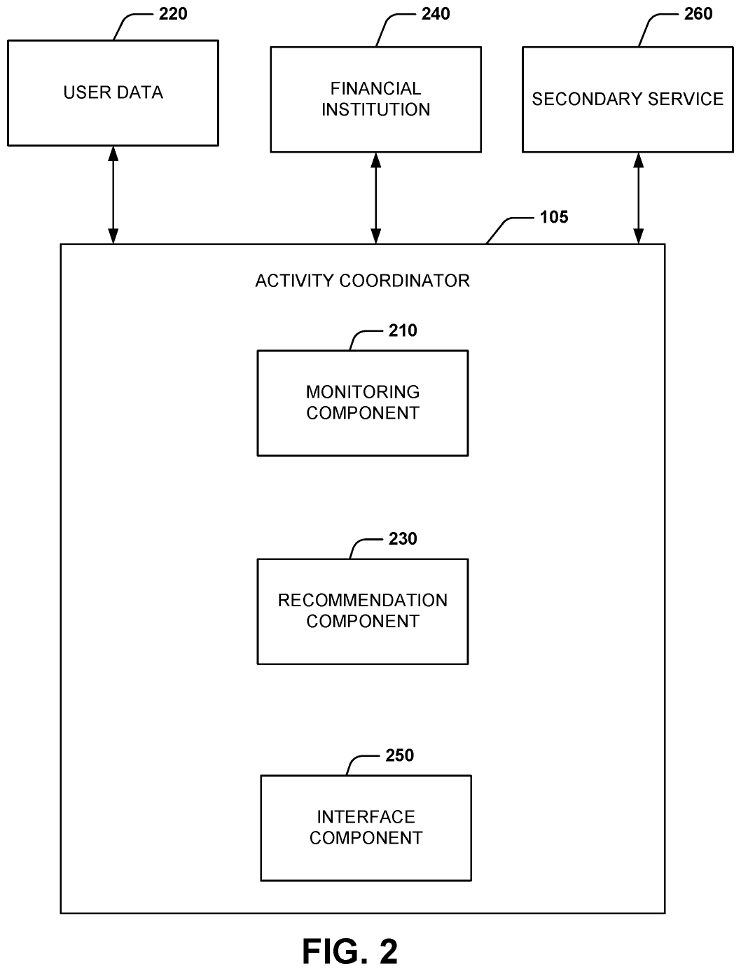

FIG. 2 illustrates a detailed component diagram of the activity coordinator 105. The activity coordinator 105 includes a monitoring component 210. The monitoring component 210 can detect upcoming plans for the user 115 to attend a keystone activity 120. The activity coordinator 105 can detect plans 110 by monitoring user data 220. The monitoring component 210 searches the user data 220 for transactions, correspondence, and activities to detect plans 110 and/or the keystone activity 120. For example, the monitoring component 210 can monitor the user's 115 email to search for ticket receipts, reservations, conversations that set up a keystone activity 120, and/or the like. The monitoring component 210 can utilize optical character recognition OCR, natural language processing NLP, machine learning techniques, computer vision CV, and/or the like to monitor the user 115. For example, the monitoring component 210 can determine a user transaction with a ticketing website. The monitoring component 210 can, e.g., with permission, access the user's 115 text messages for a receipt or a conversation with a friend regarding a keystone activity 120. The monitoring component 210 utilizes natural language processing to read the text messages to confirm plans 110 for the keystone activity 120.

The activity coordinator 105 includes a recommendation component 230. The recommendation component 230 generates activity recommendations 125 based on the keystone activity 120. The recommendation component 230 generates one or more secondary activities 130. The recommendation component 230 presents the activity recommendations to the user 115 via a user device 135. Secondary activities can be activities that are related to the keystone activity 120. For example, if the keystone activity 120 is a movie showing at a cinema, a secondary activity 130 can be transportation to and/or from the cinema or a dining reservation near the cinema for after the movie showing. The recommendation component 230 can automatically schedule the transportation or reservation or present the options to the user 115 to confirm the secondary activity 130 selection.

The recommendation component 230 generates activity recommendations for the user 115 via a variety of techniques. In some embodiments, the recommendation component 230 determines other users that are attending the keystone activity 120. The recommendation component 230 can further determine secondary activities that the other users have planned to base the activity recommendations around.

In other embodiments, the recommendation component 230 can determine customers that are similar to the user 115. For example, the recommendation component 230 can access customer information of a plurality of customers associated with a financial institution 240. The recommendation component 230 can determine similar customers of the financial institution 240 to the user that match attributes of the user 115. In some embodiments, the recommendation component 230 can determine a similarity score between the customer and customer data of the financial institution. The recommendation component 230 determines a set of similar customers to the customer based on the similarity score exceeding a threshold score. The recommendation component 230 analyzes transaction data of the set of similar customers to determine the activity recommendation. For example, if a majority of the set of similar customers have a transaction for a rideshare transportation to the same area as the keystone activity 120, the recommendation component 230 recommends that the user 115 use a rideshare transportation service as a transportation recommendation instead of driving and parking a personal vehicle.

In some embodiments, the recommendation component 230 can base the activity recommendations 125 on transaction data of the user 115 and/or other customer data of the financial institution 240. The recommendation component 230 can analyze the transaction data according to a recommendation model. The recommendation model can be a model that is trained with the customer data of the financial institution using a machine learning technique to learn trends and/or relationships between data points. The recommendation model can determine or predict a likelihood of a secondary activity 130 being needed or wanted and provide the secondary activities that the user 115 would most likely book.

In other embodiments, the recommendation component 230 can optimize the activity recommendations 125 for further data factors. The data factors can include at least one of distance, demographic, weather, transaction history, social media, wearable device data, augmented reality visualization of the user 115, and/or the like. The data factors can be part of the recommendation model to optimize the activity recommendations.

The recommendation component 230 utilizes the different data factors for optimization. In some embodiments, the recommendation component 230 uses a distance factor to optimize the activity recommendations. For example, the recommendation component 230 leverages mapping data such as location and transportation times to minimize recommendations that are not within walking/driving distance. In other embodiments, the recommendation component 230 uses a demographic factor to optimize the activity recommendations. For example, the recommendation component 230 leverages collaborative filtering to predict the utility of a potential recommendations based on the user's 115 demographic similarity to other users such as similarities between users of the same age group who have small children.

In other embodiments, the recommendation component 230 uses a weather factor to optimize the activity recommendations. For example, the recommendation component 230 leverages publicly available weather APIs. Such as minimizing the value of outdoor activities if the weather is rainy. The recommendation component 230 uses weather on the dates of past purchases by other customers at potential recommendation spots as a data factor. In some embodiments, the recommendation component 230 uses past purchases to optimize the activity recommendations. For example, the recommendation component 230 leverages the past purchases to recommend restaurants that are within the user's 115 typical budget range and/or recommend merchants from categories the user 115 has frequented in the past, e.g. the user frequents bookstores.

In some embodiments, the recommendation component 230 uses a fitness factor to optimize the activity recommendations. For example, the recommendation component 230 leverages information from a fitness application, wearable device, internet of things device, and/or the like to optimize the activity recommendations. For example, the recommendation component 230 determines the user tends to have high step counts on a fitness wearable device. The recommendation component 230 can increase the value of active activities such as nearby hiking routes.

In some embodiments, the recommendation component 230 uses a social media factor to optimize the activity recommendations. The recommendation component 230 can integrate with a social media account. For example, the recommendation component 230 can use a web crawling technique and/or computer vision CV technology to determine what kind of activities or foods the user prefers. The recommendation component 230 can use natural language processing NLP to group keywords associated with potential recommendations (e.g. from geotagged public social media posts), and characterize a potential activity recommendation as appropriate for a certain mood or activity level.

In some embodiments, the recommendation component 230 uses a mood factor to optimize the activity recommendations. For example, the recommendation component 230 leverages data from a wearable device that can measure galvanic skin response, heart rate, heart rate variability, and/or the like. The recommendation component 230 can utilize the mood data and match the mood to the user's previous activities to build a picture of moods over time. In other embodiments, the recommendation component 230 uses an augmented reality factor to optimize the activity recommendations. For example, the recommendation component 230 leverages an augmented reality AR visualizations for the user's 115 searching trends to factor for the activity recommendations.

In some embodiments, the activity coordinator 105 includes an interface component 250. The interface component 250 can access a secondary service 260. The interface component 250 can access the secondary service 260 over a network, server, internet connection, wireless network, wired network, and/or the like. In some embodiments, the interface component 250 can utilize an application programming interface API to send and receive data from the secondary service 260. The secondary service 260 can be an application on a user device, a cloud application, and/or the like. The secondary service 260 can be associated with a user account that can schedule secondary activities for the user. For example, the secondary service 260 can be a rideshare application associated with the user and/or user account. The interface component 250 can send a command (or interface with) for the secondary service 260 to schedule a recommended secondary activity using the secondary service 260.

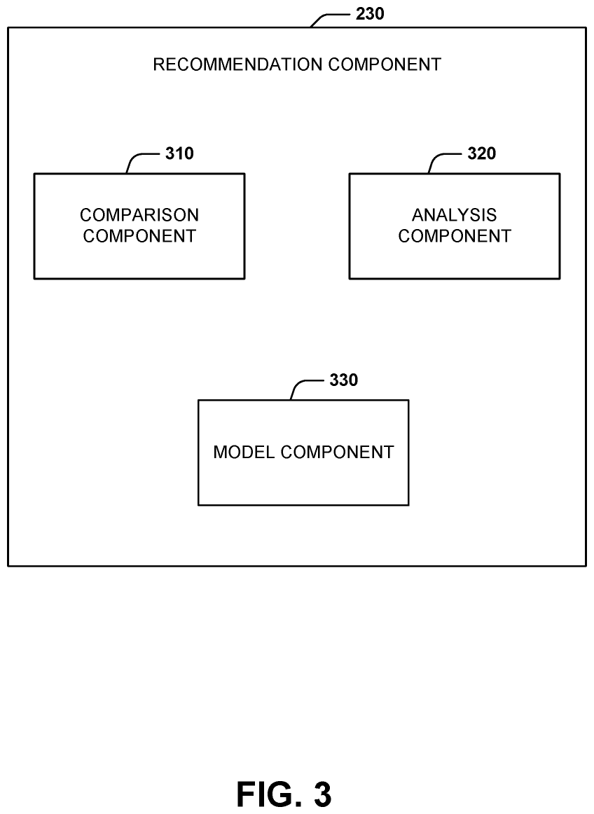

FIG. 3 illustrates a detailed component diagram of a recommendation component 230. The recommendation component 230 include a comparison component 310. The comparison component 310 can determine customers that are similar to the user 115. For example, the comparison component 310 can access customer information of a plurality of customers associated with a financial institution 240. The comparison component 310 can determine similar customers of the financial institution 240 to the user that match attributes of the user 115. In some embodiments, the comparison component 310 can determine a similarity score between the customer and customer data of the financial institution. The comparison component 310 determines a set of similar customers to the customer based on the similarity score exceeding a threshold score.

The recommendation component 230 includes an analysis component 320. The analysis component 320 analyzes transaction data of the set of similar customers to determine the activity recommendation. For example, if a majority of the set of similar customers have a transaction at a nearby restaurant in the same area as the keystone activity 120, the analysis component 320 recommends that the user 115 book a reservation at the restaurant (e.g. a dining recommendation).

In some embodiments, the analysis component 320 can base the activity recommendations 125 on transaction data of the user 115 and/or other customer data of the financial institution 240. The analysis component 320 generates activity recommendations 125 based on the keystone activity 120. The analysis component 320 generates one or more secondary activities 130. The analysis component 320 presents the activity recommendations to the user 115 via a user device 135. Secondary activities can be activities that are related to the keystone activity 120. For example, if the keystone activity 120 is a movie showing at a cinema, a secondary activity 130 can be transportation to and/or from the cinema or a restaurant reservation near the cinema for after the movie showing. The analysis component 320 can automatically schedule the transportation or reservation or present the options to the user 115 to confirm the secondary activity 130 selection.

The analysis component 320 generates activity recommendations for the user 115 via a variety of techniques. In some embodiments, the analysis component 320 determines other users that are attending the keystone activity 120. The analysis component 320 can further determine secondary activities that the other users have planned to base the activity recommendations around.

In some embodiments, the analysis component 320 determines activity recommendations in a sequence and/or timing around the keystone activity 120. For example, the analysis component 320 analyze the transaction data to determine when the user 115 typically likes to eat dinner. The analysis component 320 can determine whether the user 115 would prefer to eat before or after the keystone activity 120. The analysis component 320 can determine how much time the user 115 usually uses to complete a secondary activity 130. For example, the analysis component 320 can correlate a dining reservation with a timestamped transaction at the restaurant to determine how long the user 115 likes to take to complete a meal at the restaurant.

The recommendation component 230 includes a model component 330. The model component 330 can analyze the transaction data according to a recommendation model. The recommendation model can be a model that is trained with the customer data of the financial institution using a machine learning technique to learn trends and/or relationships between data points. The recommendation model can determine a likelihood of a secondary activity 130 being needed or wanted and provide the secondary activities that the user 115 would most likely book.

The model component 330 develops the recommendation model according to transaction data of the user and the set of similar customers. The model component 330 can train the recommendation model via a machine learning technique using a set of similar customer data and/or previous transactions. The recommendation model can be trained via purchase data or transaction data of a set of customers that are similar to the user 115.

The recommendation model can be trained via purchase data or transaction data of a set of customers that are similar to the user 115. The similarity can be based on demographics, income, location, and/or the like. In some embodiments, the set of similar customers can be determined by comparing a similarity score of each customer or a subset of disparate customers to a similarity score of the user 115. The recommendation component 230 can access a financial institution 240. The financial institution 240 stores customer information for the set of customers. The customer information can be analyzed to generate a set of customers that are similar demographically to the user. The model component 330 can determine the secondary activities using the set of similar customers. For example, the set of customers all have similar incomes as that of the user 115. The model component 330 and/or recommendation model can determine a second activity that is most commonly purchased by the set of customers (e.g. a purchase recommendation).

In some embodiments, the model component 330 optimizes the recommendation model according to further data factors. The data factors can include at least one of distance, demographic, weather, transaction history, social media, wearable device data, augmented reality visualization of the user 115, and/or the like. The data factors become part of the recommendation model to optimize the activity recommendations 125.

The model component 330 can further develop the recommendation model over time. For example, the model component 330 can keep track of secondary activities that the user 115 is presented with and which secondary activities are accepted/rejected. The model component 330 updates the recommendation model according to the user's 115 live selections.

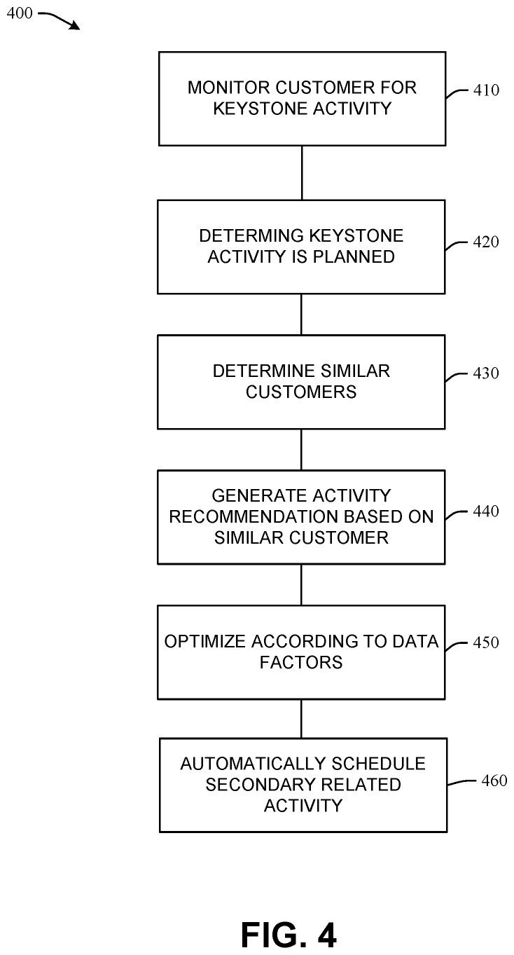

With reference to FIG. 4, example method 400 is depicted for keystone activity based recommendations. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 400 are described in conjunction with a specific example is for explanation purposes.

FIG. 4 illustrates a method 400 for keystone activity based suggestions. At 410, a user 115 is monitored for keystone activities. At 420, a keystone activity or plans for a keystone activity are detected. The user 115 can be monitored using correspondence, transactions, social media posts, and/or the like to find plans to attend a keystone activity 120. At 430, a set of similar customers to the user 115 is determined. An activity coordinator 105 can determine the set of similar customers of a financial institution to the user 115 by matching or factoring transaction histories, demographic data, customer interests, and/or the like.

At 440, activity recommendations are generated based on the set of similar customers and/or the user's 115 transaction history. The activity coordinator 105 can use a recommendation model to determine the activity recommendations. The recommendation model can be determines using machine learning techniques to train the model using transaction histories. At 450, the activity recommendations can be optimized according to data factors. The activity coordinator 105 can factor in distance, demographic, weather, transaction history, social media, wearable device data, augmented reality visualization of the user 115, and/or the like. At 460, a secondary activity of the activity recommendations can be automatically selected and scheduled. For example, the activity coordinator 105 can schedule a rideshare transportation for when the keystone activity is determined to end.

The innovation disclosed and claimed herein, in one aspect thereof, comprises systems and methods of keystone activity based suggestions. A method for planning a secondary activity related to a keystone activity of a user, comprising: analyzing financial transaction data, correspondence data, and past activity data of the user; determining the keystone activity of the user based on the analysis of the financial transaction data, correspondence data, and past activity data, wherein the keystone activity is an upcoming event for the user; analyzing a set of data factors related to the analysis of the financial transaction data, correspondence data, and past activity data in view of the keystone activity; and predicting, via a recommendation model, an activity recommendation for the user based on the analysis of the set of data factors, wherein the activity recommendation is the secondary activity that succeeds the keystone activity.

A system that schedules a secondary activity in view of a keystone activity of a user, comprising one or more processors having instructions. The instructions comprise: analyzing a first set of financial transaction data of a user; identifying the keystone activity of the user based on the analysis of the first set of financial transaction data, wherein the keystone activity is a planned event for the user; training a recommendation model according to a set of data factors associated with the keystone activity and the user; identifying the secondary activity based on the recommendation model; and scheduling the secondary activity via a secondary service based on the recommendation model.

A method of suggesting a secondary activity that succeeds a keystone activity, comprising: analyzing financial transaction data of a user; identifying the keystone activity of the user based on a result of the analysis, wherein the keystone activity is a planned event for the user; accessing customer data of a financial institution, wherein the customer data includes financial transaction data of disparate customers of the financial institution; determining a similarity score between the financial data of the user and the customer data of the financial institution; determining a set of similar customers to the user based on the similarity score; analyzing financial transaction data of the set of similar customers; determining a secondary activity based on the analysis of the financial transaction data of the set of similar customers in view of a recommendation model that is trained with historical transaction data of customers of the financial institution; and suggesting the secondary activity for the user via a financial services application installed on a mobile device.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

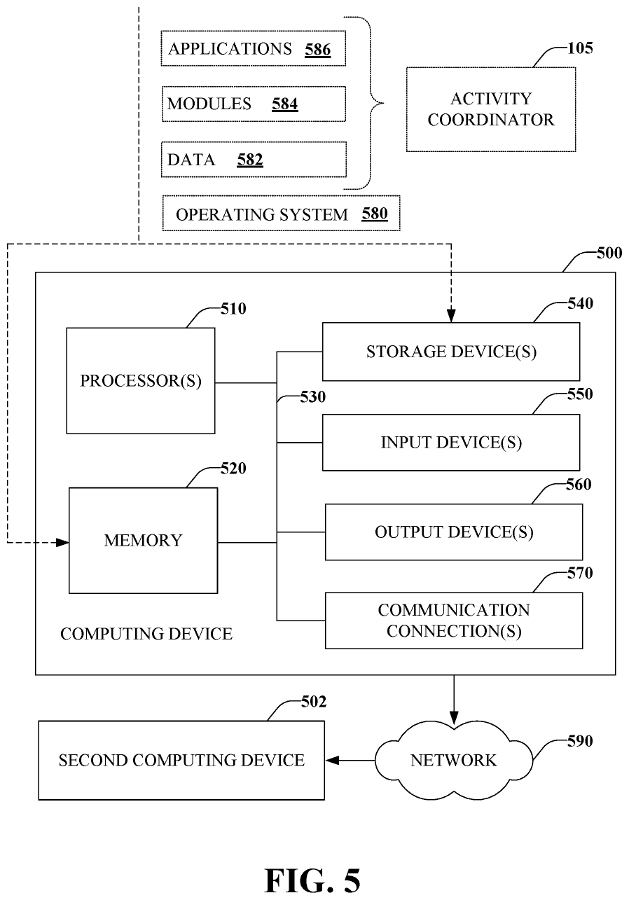

To provide a context for the disclosed subject matter, FIG. 5 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 5, illustrated is an example computing device 500 (e.g., desktop, laptop, tablet, watch, server, hand-held, programmable consumer or industrial electronics, set-top box, game system, compute node . . . ). The computing device 500 includes one or more processor(s) 510, memory 520, system bus 530, storage device(s) 540, input device(s) 550, output device(s) 560, and communications connection(s) 570. The system bus 530 communicatively couples at least the above system constituents. However, the computing device 500, in its simplest form, can include one or more processors 510 coupled to memory 520, wherein the one or more processors 510 execute various computer executable actions, instructions, and or components stored in the memory 520.

The processor(s) 510 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 510 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 510 can be a graphics processor unit (GPU) that performs calculations with respect to digital image processing and computer graphics.

The computing device 500 can include or otherwise interact with a variety of computer-readable media to facilitate control of the computing device to implement one or more aspects of the disclosed subject matter. The computer-readable media can be any available media that accessible to the computing device 500 and includes volatile and nonvolatile media, and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 500. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 520 and storage device(s) 540 are examples of computer-readable storage media. Depending on the configuration and type of computing device, the memory 520 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 500, such as during start-up, can be stored in nonvolatile memory, while volatile memory can act as external cache memory to facilitate processing by the processor(s) 510, among other things.

The storage device(s) 540 include removable/non-removable, volatile/non-volatile storage media for storage of vast amounts of data relative to the memory 520. For example, storage device(s) 540 include, but are not limited to, one or more devices such as a magnetic or optical disk drive, floppy disk drive, flash memory, solid-state drive, or memory stick.

Memory 520 and storage device(s) 540 can include, or have stored therein, operating system 580, one or more applications 586, one or more program modules 584, and data 582. The operating system 580 acts to control and allocate resources of the computing device 500. Applications 586 include one or both of system and application software and can exploit management of resources by the operating system 580 through program modules 584 and data 582 stored in the memory 520 and/or storage device(s) 540 to perform one or more actions. Accordingly, applications 586 can turn a general-purpose computer 500 into a specialized machine in accordance with the logic provided thereby.

All or portions of the disclosed subject matter can be implemented using standard programming and/or engineering techniques to produce software, firmware, hardware, or any combination thereof to control the computing device 500 to realize the disclosed functionality. By way of example and not limitation, all or portions of the activity coordinator 105 can be, or form part of, the application 586, and include one or more modules 584 and data 582 stored in memory and/or storage device(s) 540 whose functionality can be realized when executed by one or more processor(s) 510.

In accordance with one particular embodiment, the processor(s) 510 can correspond to a system on a chip (SOC) or like architecture including, or in other words integrating, both hardware and software on a single integrated circuit substrate. Here, the processor(s) 510 can include one or more processors as well as memory at least similar to the processor(s) 510 and memory 520, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the activity coordinator 105 and/or functionality associated therewith can be embedded within hardware in a SOC architecture.

The input device(s) 550 and output device(s) 560 can be communicatively coupled to the computing device 500. By way of example, the input device(s) 550 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 560, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 550 and output device(s) 560 can be connected to the computing device 500 by way of wired connection (e.g., bus), wireless connection (e.g., Wi-Fi, Bluetooth . . . ), or a combination thereof.

The computing device 500 can also include communication connection(s) 570 to enable communication with at least a second computing device 502 by means of a network 590. The communication connection(s) 570 can include wired or wireless communication mechanisms to support network communication. The network 590 can correspond to a local area network (LAN) or a wide area network (WAN) such as the Internet. The second computing device 502 can be another processor-based device with which the computing device 500 can interact. For example, the computing device 500 can correspond to a server that executes functionality of the activity coordinator 105, and the second computing device 502 can be a user device that communications and interacts with the computing device 500.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method for planning a secondary activity related to a keystone activity of a user, comprising:
analyzing financial transaction data, correspondence data, and past activity data of the user;
determining the keystone activity of the user based on the analysis of the financial transaction data, correspondence data, and past activity data, wherein the keystone activity is an upcoming event for the user;
analyzing a set of data factors related to the analysis of the financial transaction data, correspondence data, and past activity data in view of the keystone activity; and
predicting, via a recommendation model, an activity recommendation for the user based on the analysis of the set of data factors, wherein the activity recommendation is the secondary activity that succeeds the keystone activity.

2. The method of claim 1, the determining comprising:
generating the recommendation model via machine learning techniques that utilize the financial transaction data, correspondence data, and past activity data as inputs for training data.

3. The method of claim 1, further comprising:
accessing customer data of a financial institution that includes financial transaction data of customers of the financial institution;
determining a similarity score between the user and the customer data of the financial institution; and
determining a set of similar customers to the user based on the similarity score.

4. The method of claim 3, further comprising:
analyzing a second set of data factors associated with the set of similar customers; and
employing the analysis of the second set of data factors in predicting the activity recommendation.

5. The method of claim 4, further comprising:
wherein the second set of data factors is analyzed according to a second recommendation model that is trained with customer data of the set of similar customers.

6. The method of claim 5, further comprising:
determining the user follows the activity recommendation; and
updating the recommendation model with the determination to optimize the recommendation model.

7. The method of claim 1, further comprising:
wherein the activity recommendation is at least one of a transportation recommendation, a dining recommendation, or a purchase recommendation.

8. The method of claim 1,
wherein the set of data factors include at least one of distance, demographic, weather, transaction history, social media, wearable device data, or augmented reality visualization of the user.

9. The method of claim 8, further comprising:
wherein the activity recommendation is automatically scheduled for the user based on the activity recommendation.

10. A system that schedules a secondary activity in view of a keystone activity of a user, comprising:
one or more processors having instructions, the instructions comprising:
analyze a first set of financial transaction data of a user;
identify the keystone activity of the user based on the analysis of the first set of financial transaction data, wherein the keystone activity is a planned event for the user;
train a recommendation model according to a set of data factors associated with the keystone activity and the user;
identify the secondary activity based on the recommendation model; and
schedule the secondary activity via a secondary service based on the recommendation model.

11. The system of claim 10, further comprising:
determine attendance of the user at the keystone activity via monitoring user transactions, correspondence, or user activities.

12. The system of claim 10, further comprising:
access customer data of a financial institution, wherein the customer data includes data of a plurality of disparate customers of the financial institution;
determine a similarity score between the user and a subset of the plurality of disparate customers; and
identify a set of similar customers to the user based on the similarity score.

13. The system of claim 12, further comprising
analyze a second set of financial transaction data that is associated with the set of similar customers; and
employ the analysis of the second set of financial transaction data to predict the secondary activity.

14. The system of claim 13, further comprising:
wherein the second set of transaction data is analyzed according to the recommendation model that is trained with the customer data of the financial institution using a machine learning technique.

15. The system of claim 14, further comprising
determine attendance of the user at the secondary activity; and
update the recommendation model with the attendance to optimize the recommendation model.

16. The system of claim 10, further comprising:
wherein the secondary activity is at least one of a transportation recommendation, a dining recommendation, or a purchase recommendation.

17. The system of claim 10, further comprising:
wherein the set of data factors include at least one of distance, demographic, weather, transaction history, social media, wearable device data, or augmented reality visualization of the user.

18. The system of claim 17, further comprising:
wherein the secondary activity is one of a set of activity recommendations generated based on the recommendation model in view of a similarity score of disparate customers of a financial institution.

19. A method of suggesting a secondary activity that succeeds a keystone activity, comprising:
analyzing financial transaction data of a user;
identifying the keystone activity of the user based on a result of the analysis, wherein the keystone activity is a planned event for the user;
accessing customer data of a financial institution, wherein the customer data includes financial transaction data of disparate customers of the financial institution;
determining a similarity score between the financial transaction data of the user and the customer data of the financial institution;
determining a set of similar customers to the user based on the similarity score;
analyzing financial transaction data of the set of similar customers;
determining a secondary activity based on the analysis of the financial transaction data of the set of similar customers in view of a recommendation model that is trained with historical transaction data of customers of the financial institution; and
suggesting the secondary activity for the user via a financial services application installed on a mobile device.

20. The method of claim 19, comprising:
interfacing with a secondary service installed on the mobile device to schedule the secondary activity.
